(19) United States
(12) Patent Application Publication
(10) Pub. No.: US 2012/0002227 A1
(43) Pub. Date: Jan. 5, 2012

(54) IMAGE FORMING APPARATUS

(75) Inventor: Kosuke Ogino, Susono-shi (JP)

(73) Assignee: CANON KABUSHIKI KAISHA, Tokyo (JP)

(21) Appl. No.: 13/155,040

(22) Filed: Jun. 7, 2011

(30) Foreign Application Priority Data
Jun. 30, 2010 (JP) 2010-149489
Sep. 16, 2010 (JP) 2010-208025

(51) Int. Cl. G06K 15/00; B65H 7/02

(52) U.S. Cl. 358/1.12; 271/265.01

(57) ABSTRACT

A value for determining a type of a recording medium is compared with a detection result, and the type of the recording medium is confirmed when there is no detection result within a predetermined range. Thus, by controlling the number of recording media to be detected for confirming the type of the recording medium according to the determination result of the recording media, a drop in productivity during determination of the types of the recording media is reduced.

### BACKGROUND OF THE INVENTION

1. Field of the Invention

The present invention relates to a method for determining a type of a recording medium used in an image forming apparatus such as a copying machine or a laser printer.

2. Description of the Related Art

Conventionally, to determine the type of a recording medium used in an image forming apparatus, there are used a method for setting the type of the recording medium by a user via a panel included in an image forming apparatus body, and a method for determining the type of the recording medium by using a sensor included in the image forming apparatus.

Among such methods for determining the type of the recording medium, as the method for determining the type of the recording medium in the image forming apparatus, for example, Japanese Patent Application Laid-Open No. 2007-055814 discusses a method that determines, since determination of types of all recording media to be supplied leads to lowered productivity, only a predefined number of recording media from the start of supplying the recording media, and confirms the type of the recording media stacked in a feeding unit based on a result of the determination, thereby reducing a drop in productivity by shortening the time for determining the recording media more than that in the case of determining all the recording media.

Determining the recording media based on the detection result of the predefined number of recording media as in the conventional case enables shortening of time for determining the recording media. However, the conventional method has an issue of, irrespective of a determination result of the recording media, an inevitable drop in productivity equivalent to the time for determining the predefined number of recording media.

### SUMMARY OF THE INVENTION

The present invention is directed to an image forming apparatus capable of reducing a drop in productivity during determination of types of recording media.

According to an aspect of the present invention, an image forming apparatus includes a detection unit configured to detect a value indicating a type of a recording medium, and a control unit configured to end the detection performed by the detection unit when a difference between a first value detected by the detection unit and a threshold value is larger than a predetermined value, continue the detection performed by the detection unit when the difference between the first detection value detected by the detection unit and the threshold value is smaller than the predetermined value, and end the detection performed by the detection unit when a difference between a second value detected after the first value by the detection unit and the threshold value is larger than the predetermined value.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 schematically illustrates a configuration of an image forming apparatus.

FIG. 2 is a block diagram illustrating an engine control unit of the image forming apparatus.

FIG. 3 schematically illustrates a configuration of a recording medium determination sensor.

FIG. 4 is a flowchart illustrating a method for determining a type of a recording medium according to a first exemplary embodiment.

FIG. 5 illustrates a recording medium determination table for determining the type of the recording medium according to the first exemplary embodiment

FIGS. 6A, 6B, and 6C illustrate comparisons of the method for determining the type of the recording medium according to the first exemplary embodiment with a conventional method for determining a type of a recording medium.

FIG. 7 illustrates a recording medium determination table for determining a type of a recording medium according to a second exemplary embodiment.

FIG. 8 is a flowchart illustrating a method for determining a type of a recording medium according to a third exemplary embodiment.

FIG. 9 illustrates a recording medium determination table for determining the type of the recording medium according to the third exemplary embodiment.

FIGS. 10A and 10B are timing charts illustrating conveying positions and timings of recording media and toner images.

FIG. 11 (11A and 11B) is a flowchart illustrating control of a transmission timing of a /TOP signal according to a fourth exemplary embodiment.

FIGS. 12A and 12B are flowcharts illustrating methods for determining numbers of times of measuring reflected light and transmitted light according to the fourth exemplary embodiment.

FIG. 13 illustrates a recording medium determination table for determining a type of a recording medium according to the fourth exemplary embodiment.

### DESCRIPTION OF THE EMBODIMENTS

Various exemplary embodiments, features, and aspects of the invention will be described in detail below with reference to the drawings.

The exemplary embodiments described below are in no way limitative of the invention specified in appended claims, and all combinations of features described in the exemplary embodiments are not essential to a solution of the invention.

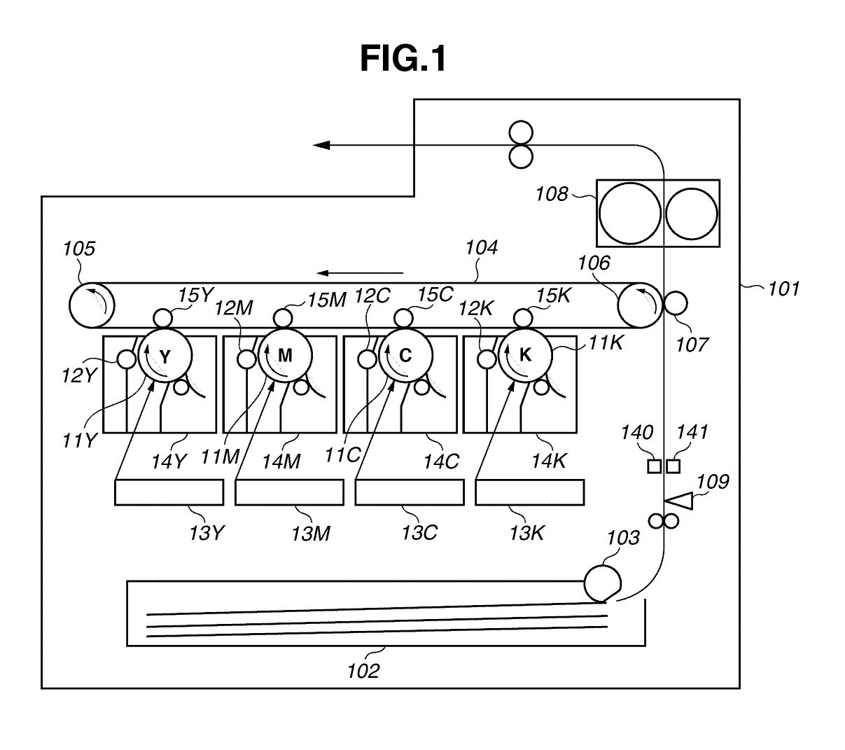

FIG. 1 schematically illustrates a configuration of an image forming apparatus. The image forming apparatus 101 includes: a feeding cassette 102 for housing recording media; a feeding roller 103 for feeding the recording media from the feeding cassette 102; a registration sensor 109 for detecting a size of a recording medium or a conveying failure; a light emitting diode (LED) serving as a light emitting unit that is a sensor for determining a type of a recoding medium; and a phototransistor serving as a light receiving unit that is a sensor for determining the type of the recording medium.

Photosensitive drums 11Y, 11M, 11C, and 11K respectively bear developers of yellow, magenta, cyan, and black. Charging rollers 12Y, 12M, 12C, and 12K serve as primary charging units for the respective colors to uniformly charge the photosensitive drums 11Y, 11M, 11C, and 11K to a predetermined potential. Optical units 13Y, 13M, 13C, and 13K irradiates the photosensitive drums 11Y, 11M, 11C, and 11K charged by the primary charging units with laser beams corresponding to image data of the respective colors to form electrostatic latent images thereon.

Developing devices 14Y, 14M, 14C, and 14K visualize the electrostatic latent images formed on the photosensitive drums 11Y, 11M, 11C, and 11K. Primary transfer rollers 15Y, 15M, 15C, and 15K for the respective colors primary-transfer the images formed on the photosensitive drums 11Y, 11M, 11C, and 11K.

An intermediate transfer belt 104 bears the primary-transferred images. A driving roller 105 drives the intermediate transfer belt 104. A secondary transfer roller 106 transfers the images formed on the intermediate transfer belt 104 to a recording medium. A secondary transfer counter roller 107 faces the secondary transfer roller 106. A fixing unit 108 melts and fixes the developer images transferred to the recording medium while conveying the recording medium.

The photosensitive drums 11Y, 11M, 11C, and 11K, the charging rollers 12Y, 12M, 12C, and 12K, and the developing devices 14Y, 14M, 14C, and 14K are integrated for the respective colors. The photosensitive drum, the charging roller, and the developing device thus integrated constitute a cartridge. A cartridge of each color is configured to be easily attached/detached from an image forming apparatus body.

Next, an image forming operation of the image forming apparatus 101 is described. A host computer (not illustrated) inputs print data containing a printing command or image information to the image forming apparatus 101. Then, the image forming apparatus 101 starts a printing operation, and a recording medium is fed from the feeding cassette 102 by the feeding roller 103 to be delivered to a conveyance path.

To synchronize a conveyance timing with an image forming operation on the intermediate transfer belt 104, the recording medium is temporarily stopped at the feeding roller to stand by until an image is formed. During conveying the recording medium by the feeding roller, or stopped, a type of the recording medium is determined by the LED 140 serving as the light emitting unit that is the sensor for determining the type of the recording medium and the phototransistor 141 serving as the light receiving unit. A method for determining the recording medium is described below.

Together with the feeding operation of the recording medium, as the image forming operation, the charging rollers 12Y, 12M, 12C, and 12K charge the photosensitive drums 11Y, 11M, 11C, and 11K to a predetermined potential. Based on the input print data, the optical units 13Y, 13M, 13C, and 13K expose and scan surfaces of the charged photosensitive drums 11Y, 11M, 11C, and 11K with laser beams to form electrostatic latent images.

The formed electrostatic latent images are developed by the developing devices 14Y, 14M, 14C, and 14K and a developer feeding roller to be visualized. The electrostatic latent images formed on the surfaces of the photosensitive drums 11Y, 11M, 11C, and 11K are developed to be images of respective colors by the developing devices 14Y, 14M, 14C, and 14K. The photosensitive drums 11Y, 11M, 11C, and 11K are in contact with the intermediate transfer belt 104, and rotate in synchronization with the rotation of the intermediate transfer belt 104.

The developed images are sequentially transferred onto the intermediate transfer belt 104 in a multiple manner by the primary transfer rollers 15Y, 15M, 15C, and 15K. The images are then secondary-transferred onto the recording medium by the secondary transfer roller 106 and the secondary transfer counter roller 107.

Subsequently, in synchronization with the image forming operation, to perform secondary-transfer to the recording medium, the recording medium is conveyed to a secondary transfer unit. The images formed on the intermediate transfer belt 104 are transferred to the recording medium by the secondary transfer roller 106 and the secondary transfer counter roller 107. The developer images transferred to the recording medium are fixed by the fixing unit 108 that includes a fixing roller. The recording medium having the images fixed thereon is discharged to a discharge tray by a discharge roller, and the image forming operation is ended.

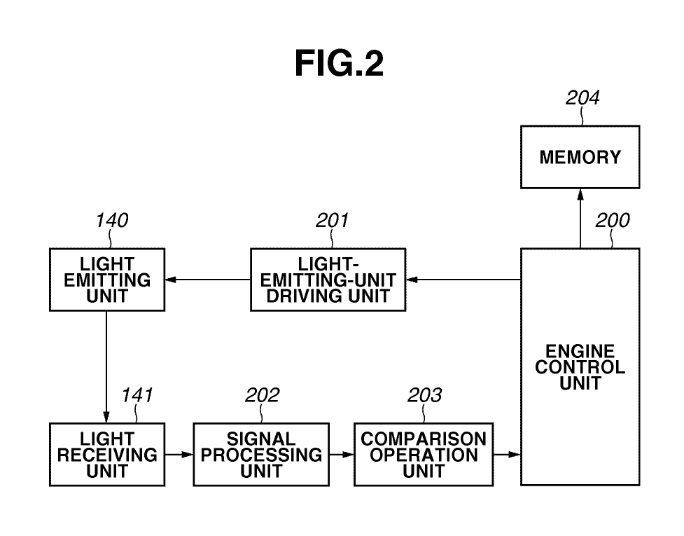

FIG. 2 is a block diagram illustrating an engine control unit of the image forming apparatus 101. The engine control unit 200 controls operations of a light-emitting-unit driving unit 201, a signal processing unit 202, and a comparison operation unit 203. The light-emitting-unit driving unit 201 includes a digital-analog (D/A) converter, and drives the LED 140 that serves as the light emitting unit.

The signal processing unit 202 calculates an output value of the phototransistor 141 serving as the light receiving unit by performing A/D conversion with 16-bit resolution. For example, as a calculation result of the output value, a specular reflection output value or a diffused reflection output value indicating glossiness of the recording medium, or transmittance indicating light transmissivity of the recording medium is acquired. The comparison operation unit 203 performs a comparison operation with a setting value prestored in a memory 204 that serves as a storage unit based on the calculation result of the signal processing unit 202.

The memory 204 is a nonvolatile memory such as an electrically erasable programmable read-only memory (EEPROM) to store a setting value for determining a type of a recording medium, or a threshold value for confirming a number of determined types of recording media or a determination number of times.

The memory 204 also stores a value of an emitted light amount for the light emitting unit 140. For example, at the time of factory shipment, by using reference paper, an amount of specular reflected light and an amount of diffused reflected light are measured from the reference paper. A value of an emitted light amount for the light receiving unit 141 is stored in the memory 204 based on a result of the measurement.

The value of the emitted light amount is set for the light receiving unit 141 because sensitivity variance of the light receiving unit can be canceled by changing the amount of light emitted by the light emitting unit.

The engine control unit 200 determines whether to confirm the paper type of the remaining recording media housed in a feeding port based on the result acquired from the comparison operation unit 203 and the number of prints in the feeding port. When the type of the recording media are not confirmed, control is performed to determine the recording media during a next image forming operation executed by using the recording media in the same feeding port.

When the type of the recording media are confirmed, without determining the recording media during next image formation executed by using the recording media in an integrated feeding port, control is performed to form images according to the confirmed type of the recording media.

The engine control unit 200, the light-emitting-unit driving unit 201, the signal processing unit 202, and the comparison operation unit 203 are configured by using a one-chip central processing unit (CPU) as an example. However, these units are not limited to this example.

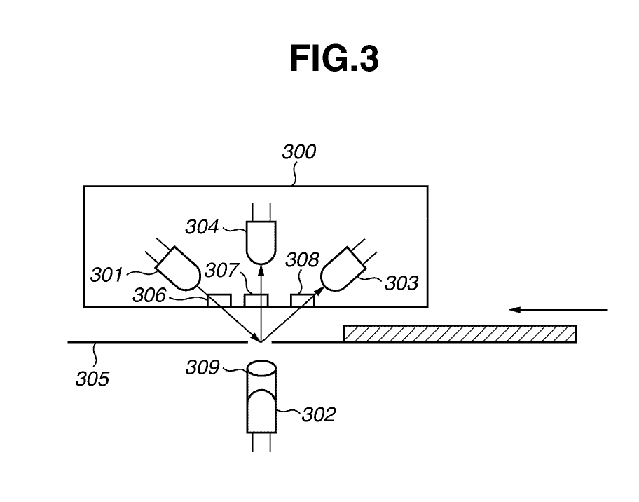

FIG. 3 illustrates a configuration of a recording medium determination sensor 300. The recording medium determination sensor 300 includes an LED 301 serving as a first irradiation unit, an LED 302 serving as a second irradiation unit, a phototransistor 303 serving as a first reading unit, and a phototransistor 304 serving as a second reading unit.

Light emitted from the LED 301 via a slit 306 is irradiated on a surface of the recording medium conveyed on a recording medium feeding guide 305. The light irradiated on the recording medium is condensed as reflected light via slits 307 and 308 to be received by the phototransistors 303 and 304. For the light emitted from the LED 301, the phototransistor 304 acquires a diffused reflection output value, and the phototransistor 303 acquires a specular reflection output value. Glossiness (specular reflection output value and diffused reflection output value) of the recording medium is accordingly detected.

Light emitted from the LED 302 is irradiated through a condensing guide 309 for condensing the light on a rear surface of the recording medium. The irradiated light is transmitted through the recording medium to be received as transmitted light by the phototransistor 304 via the slit 307.

The phototransistor 304 acquires a specular transmission output value for the light emitted from the LED 302. Transmittance of the recording medium is accordingly detected. The LED 301 is disposed so that the surface of the recording medium can be obliquely irradiated with the light at a predetermined angle. The LED 302 is disposed so that the rear surface of the recording medium can be irradiated with the light from a position opposing the phototransistor 304.

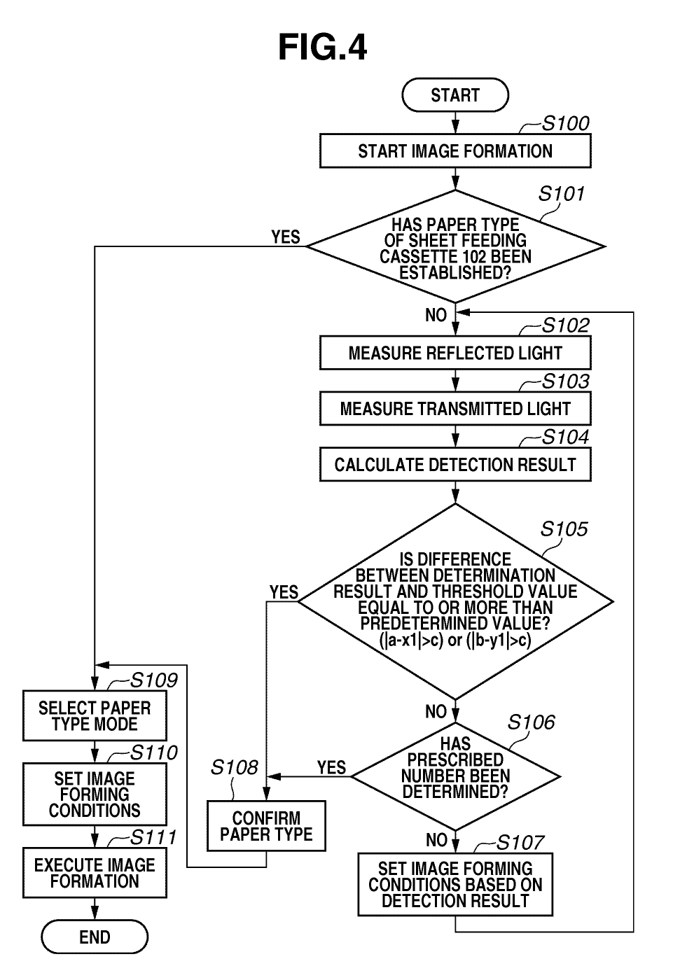

Referring to a flowchart of FIG. 4, a method for determining a type of a recording medium according to the present exemplary embodiment is described. In step S100, the engine control unit 200 starts image formation after reception of a print start instruction from an external device such as a host computer. In step S101, the engine control unit 200 determines whether the type of recording media stacked in the feeding cassette 102 has been confirmed.

When the engine control unit 200 determines that the type of the recording media stacked in the feeding cassette 102 is not yet confirmed (NO in step S101), the recording media are conveyed to the position of the recording medium determination sensor 300.

After the recording media have been conveyed to the recording medium determination sensor, the light-emitting-unit driving unit 201 causes the LED 301 to emit light based on the emitted light amount value stored in the memory 204 to irradiate the recording media with the light, and receives reflected light from the recording media by the phototransistors 303 and 304.

In step S103, the light-emitting-unit driving unit 201 stops the light emission from the LED 301, causes the LED 302 to emit light based on the emitted light amount value stored in the memory 204 to irradiate the recording media with the light, and receives transmitted light from the recording media by the phototransistor 304.

In step S104, the signal processing unit 202 calculates a ratio of a specular reflection output value or a diffused reflection output value indicating glossiness of the recording media based on the output values of light received by the phototransistors 303 and 304.

The signal processing unit 202 also calculates transmittance indicating light transmissivity of the recording media. In step S105, the comparison operation unit 203 compares glossiness (x1) and transmittance (y1) (hereinafter, detection results) of the recording media with glossiness “a” that is a threshold value for determining glossy paper and others, and transmittance “b” that is a threshold value for determining plain paper and thick paper.

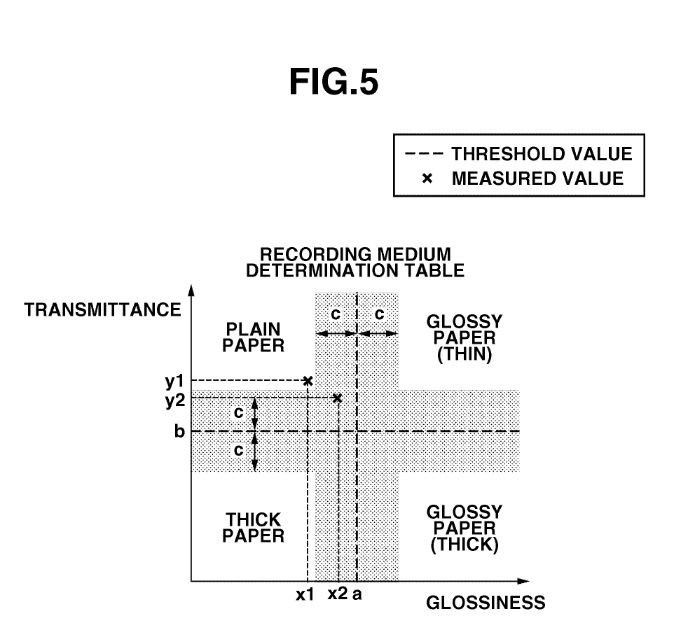

FIG. 5 illustrates a recording medium determination table that is determination information for determining types of recording media. Based on the glossiness “a” that is the threshold value for determining glossy paper and others and the transmittance “b” that is the threshold value for determining plain paper and thick paper, the recording media are classified into four types.

The engine control unit 200 determines types of the recording media by comparison as to which area of the table corresponds to the previous determination result (x1 and y1). More specifically, types of the recording media are determined based on whether there is a difference of a predetermined value (c) or more from the threshold values “a” and “b”. In other words, whether determination conditions of |a−x1|>c and |b−y1|>c are satisfied is determined.

The determination result (x1 and y1) illustrated in FIG. 5 indicates a pattern where the type of the recording media can be confirmed as plain paper. The determination result (x2 and y2) indicates a pattern where the type of the recording media is not yet confirmed.

The number of times of satisfying the determination conditions once by the determination result (x1 and y1) can be one or a plurality of times, and arbitrarily set as long as the number is equal to or less than a predetermined number of recording media described below. When the type of the recording media is confirmed bases on a plurality of times, determination can be made under conditions such as whether the same determination result continues for a plurality of recording media. Increasing the number of times of satisfying the determination conditions enables improvement of determination accuracy of the recording media.

The predetermined value “c” can be arbitrarily set according to a status of recording media to be determined such as types of recording media that take priority or types of recording media where erroneous detection easily occurs. One area for determining whether to perform detection has been described as an example. However, a plurality of areas can be set, and weighting can be performed such that the number of recording media to be continuously detected is changed from area to area.

When it is determined that the type of the recording media cannot be confirmed (NO in step S105), in step S106, the engine control unit 200 determines whether the number of determined recording media by the recording medium determination sensor 300 has reached a predetermined number.

When it is determined that the number of determined recoding media has not reached the predetermined number (NO in step S106), in step S107, with a type of the recording media determined in step S105 set as a tentative paper type, the engine control unit 200 sets image forming conditions to continue the determination of the recording media.

The setting of the tentative image forming conditions based on the detection result in step S105 is not performed for each determination of the recording media. The image forming conditions are set based on a detection result of a first recording medium until the type of the recording media is confirmed.

When it is determined that the number of determined recording media has reached the predetermined number (YES in step S106), in step S108, the engine control unit 200 confirms the type of the recording media based on a result of continuously detecting a predetermined number of recording media. In this case, the type of the recording media can be determined based on an average value of the result of detecting the predetermined number or a sheer determination number of times in the result of detecting the predetermined number.

Thus, a determination operation of recording media by predetermined number or more is not performed. The predetermined number can be arbitrarily set according to accuracy of types of recording media to be acquired.

When it is determined that neither the determination result (x1 and y1) is near the threshold values, nor the types of the recording media are determined by mistake (YES in step S105), in step S108, the engine control unit 200 confirms the type of the recording media stacked in the feeding cassette 102.

As a result, since the type of the recording media can be confirmed even when the prescribed number is not yet reached, time for determining the types of the recording media can be shortened.

When it is determined that the number of determined recording medium has reached the predetermined number (YES in step S106), the engine control unit 200 confirms the type of the recording media stacked in the feeding cassette 102. In step S109, the engine control unit 200 selects a paper type mode according to the confirmed type of the recording media.

In step S110, the engine control unit 200 sets image forming conditions according to the selected paper type mode. In step S111, the engine control unit 200 executes image formation based on the set image forming conditions.

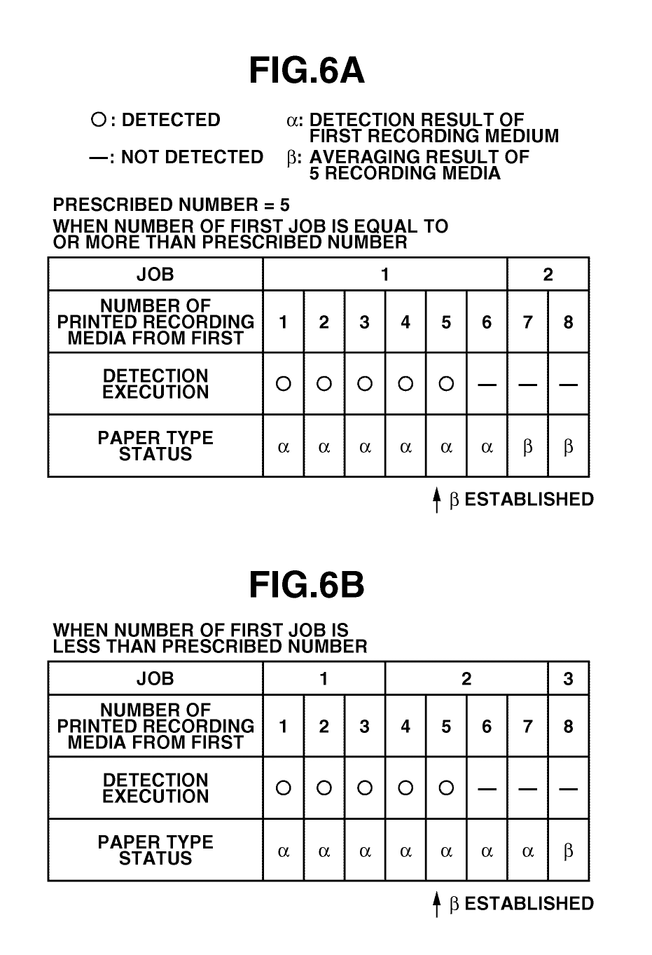

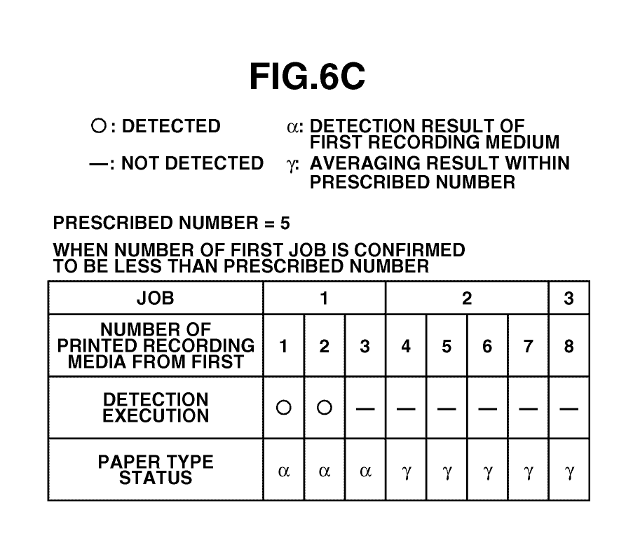

Referring to FIGS. 6A, 6B, and 6C, comparison of the method for determining the recording medium according to the present exemplary embodiment with the conventional method for determining the type of the recording medium is described. FIGS. 6A and 6B illustrate the conventional method, and FIG. 6C illustrates the method according to the present exemplary embodiment. Setting of image forming conditions for each page of a print job is illustrated.

FIGS. 6A, 6B, and 6C illustrate items including a job number, the number of prints from the first, detection execution indicating whether a type of a recording medium has been detected, and a paper type status for setting image forming conditions. An example where the prescribed number is five is illustrated.

FIG. 6A illustrates an example where there are two print jobs: the first job includes six pages, and the second job includes two pages.

First, image forming conditions are set for the first job based on a detection result α on the first page (equivalent to the number of prints 1 from the first) of the first job. Printing conditions are set for the second job based on a detection result β confirmed from the first to fifth pages. The detection result β is stored as a confirmed result of a type of a recording medium.

The image forming conditions are set to α rather than β in the first job (equivalent to the number of prints 6 from the first) after the confirmation of the type of the recording medium, because of possible changes that occur in quality or color of a formed image when the image forming conditions are changed in one job.

Changing the image forming conditions may take time, causing reduction in image forming speed. Thus, the image forming conditions are not changed in one job.

FIG. 6B illustrates an example where there are three print jobs: the first job includes three pages, the second job includes four pages, and the third job includes one page. In this case, image forming conditions for the first and second jobs are set based on a result α detected on the first page of the first job.

The type of a recording medium is confirmed in the second page (the number of prints 5 from the first) of the second job. The confirmed result β is reflected from the third job. The reason for setting the image forming conditions for the second the job based on the result α is similar to that in the example illustrated in FIG. 6A.

FIG. 6C illustrates an example where a type of a recording medium is confirmed within the prescribed number by using the method for determining the type of a recording medium according to the present exemplary embodiment. FIG. 6C illustrates an example where there are three print jobs: the first job includes three pages, the second job includes four pages, and the third job includes one page.

Image forming conditions for the first job are set based on a result a detected in the first page of the first job. The type of the recording medium is confirmed in the second page (the number of prints 2 from the first) of the first job.

According to the conventional method, detection is always performed from the first to fifth recording media. According to the present exemplary embodiment, however, no detection is performed after the confirmation of the type of the recording medium. Time for detecting the recording media is accordingly for only two. Thus, the time for detecting the recording media can be shortened more by three recording media than that in the conventional method.

The confirmed result γ is reflected from the second job. The reason for setting the image forming conditions for the third page of the first job based on the result α is similar to that in the example illustrated in FIG. 6A.

Thus, by controlling the number of detection times to determine types of the recording media according to the relationship between the determination result of the recording media and the threshold value for determining types of the recording media, a drop in productivity during determination of types of the recording media can be suppressed.

The present exemplary embodiment has been described by taking the phototransistor as the example of the light receiving unit. However, a charge-coupled device (CCD) sensor or a complementary metal-oxide semiconductor (CMOS) sensor can be used as a reading unit for reading the inside of a light irradiation area of the light emitting unit as a video. The determination result can be acquired from the video captured by the reading unit, and the type of the recording media can be confirmed within the prescribed number.

The method for confirming the type of the recording media stacked in the feeding cassette 102 according to the present exemplary embodiment has been described. There can be a plurality of feeding cassettes, and a type of a recording medium can be determined for each feeding cassette.

The first exemplary embodiment has been directed to the method for determining the types of the recording media based on the relationship between the determination result of one recording medium and the threshold value. A second exemplary embodiment is directed to a method for performing control whether to continue determination of types of recording media based on a determined type of a recording medium. Components similar to those of the first exemplary embodiment have similar reference numerals, and description thereof is omitted.

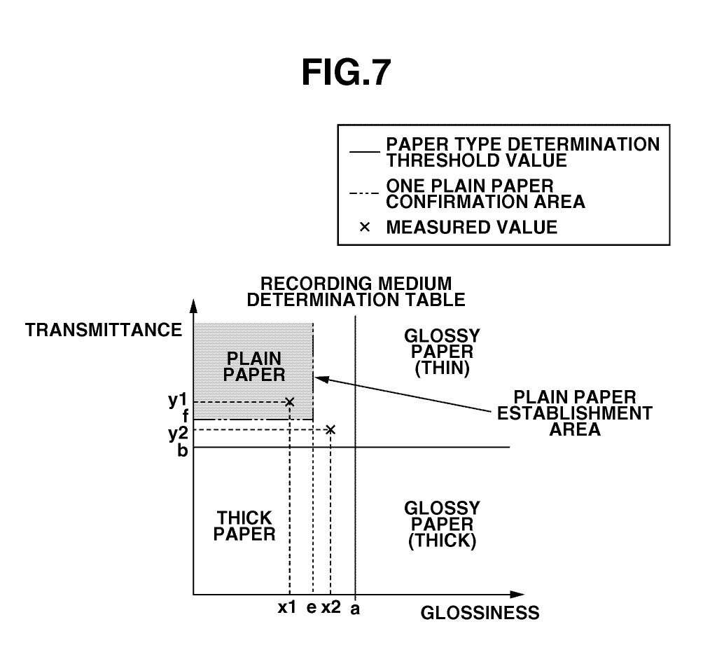

FIG. 7 illustrates a recording medium determination table that is determination information for determining types of recording media according to the present exemplary embodiment. Based on glossiness “a” that is a threshold value for determining glossy paper and others, and transmittance “b” that is a threshold value for determining plain paper and thick paper, the recording media are classified into four types.

An engine control unit 200 determines types of the recording media by comparison as to which area of the table corresponds to the previous determination result (x1 and y1). More specifically, whether determination conditions of x1<e and y1>f are satisfied is determined.

The determination result (x1 and y1) illustrated in FIG. 7 indicates a pattern where the type of the recording media can be confirmed as plain paper. A determination result (x2 and y2) indicates a pattern where the type of the recording media cannot yet be confirmed.

Thus, control is performed to end detection of types of the recording media when the type of the recording media can be confirmed to be plain paper, and continue detection of the types of the recording media until a predetermined number of times when the types of the recording paper cannot be determined to be plain paper. As a result, a drop in productivity during determination of the types of the recording media can be suppressed while keeping determination accuracy.

A reason for performing the control to end the determination operation when the types of the recording media can be confirmed to be plain paper is that when forming an image on the plain paper, a process speed is set high, and hence a drop in productivity can be effectively suppressed by ending the detection of the types of the recording media. However, setting the plain paper as a criterion is only an example. A criterion can be arbitrarily set. For example, when a recording medium is determined to be glossy paper, to improve determination accuracy, detection of types of recoding media is continued until a predetermined number of times.

The first exemplary embodiment and the second exemplary embodiment have been directed to the methods for determining the types of the recording media based on the relationship between the determination result of one recording medium and the threshold value. The present exemplary embodiment is directed to a method for determining types of recording media according to variance on determination results of two recording media. Components similar to those of the first exemplary embodiment and the second exemplary embodiment have similar reference numerals, and description thereof is omitted.

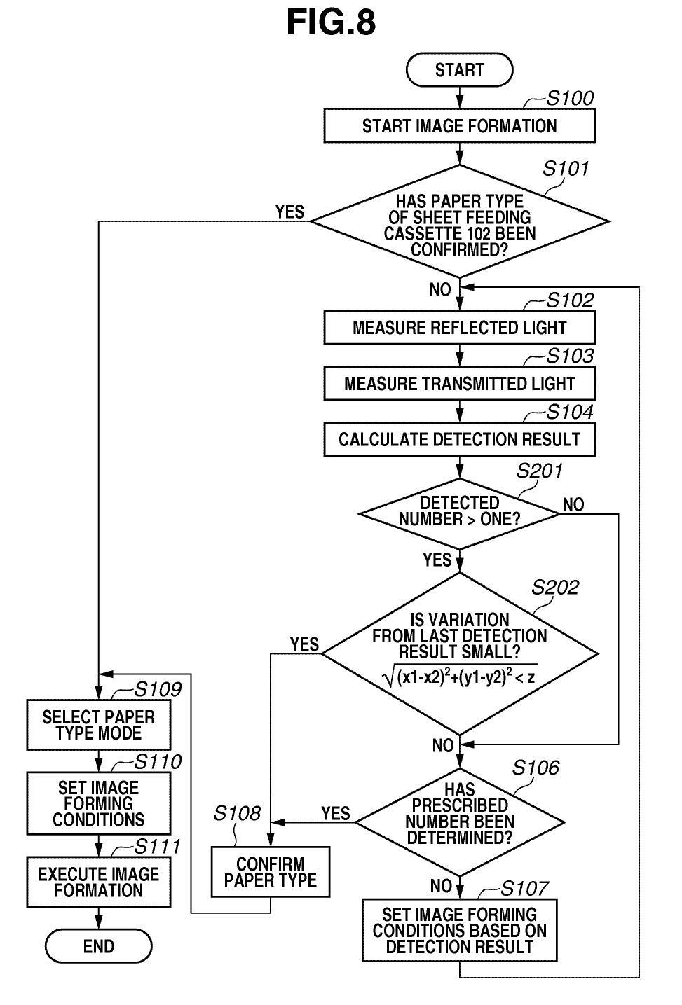

Referring to FIG. 8, the method for determining types of the recording media according to the present exemplary embodiment is described. Steps similar to those in the flowchart of the first exemplary embodiment illustrated in FIG. 4 have similar reference numerals, and description thereof is omitted.

In step S201, an engine control unit 200 determines whether the number of detected recording media is one. When it is determined that the number of detected recording media is not one (YES in step S201), then in step S202, the engine control unit 200 determines whether a difference between a current determination result (x1 and y1) and a last determination result (x2 and y2) is less than a predetermined value (z). Specifically, the engine control unit 200 determines whether the following expression (1) is satisfied:

\sqrt{(x1−x2)²+(y1−y2)²}<z (1)

In other words, when there is no variation in determination results among the recording media, and a determination result is expected to be similar for the remaining recording media (YES in step S202), the processing proceeds to step S108 to confirm the type of the recording media.

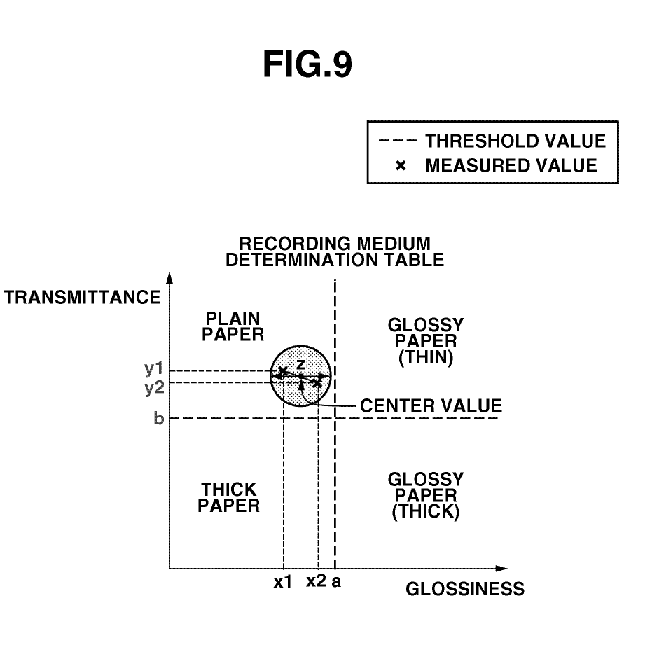

FIG. 9 illustrates a recording medium determination table. Based on glossiness “a” that is a threshold value for determining glossy paper and others, and transmittance “b” that is a threshold value for determining plain paper and thick paper, the recording media are classified into four types.

The engine control unit 200 confirms the type of the recording media when a difference value between the determination results acquired by using the expression (1) is within a range of a predetermined value “z”. When the two determination areas are different areas (e.g., thick paper and plain paper), the engine control unit 200 confirms an area of a center value that is an average value of the two determination results as the type of the recording media.

The method for confirming the type of the recording media by using the determination results of the two recording media has been described. However, the number of used recording media is not limited to two. The type of the recording media can be confirmed by using determination results of a plurality of recording media.

When a plurality of recording media is targeted, the engine control unit 200 determines whether a difference is within the predetermined value “z” by using a determination result (xm and ym) and a determination result (xn and yn) of two determination results where the difference between the determination results is largest among the plurality of recording media. Specifically, the engine control unit 200 determines whether the following expression (2) is satisfied.

\sqrt{(xm−xn)²+(ym−yn)²}<z (2)

Thus, by controlling the number of detection times for determining types of the recording media according to the difference value among the determination results of the plurality of recording media, a drop in productivity during determination of types of the recording media can be suppressed.

The first to third exemplary embodiments have been directed to the method for determining the types of the recording media. A fourth exemplary embodiment is directed to a method for controlling timing of transmitting image data when a recording medium is determined. Components similar to those of the first to third exemplary embodiments have similar reference numerals, and description thereof is omitted.

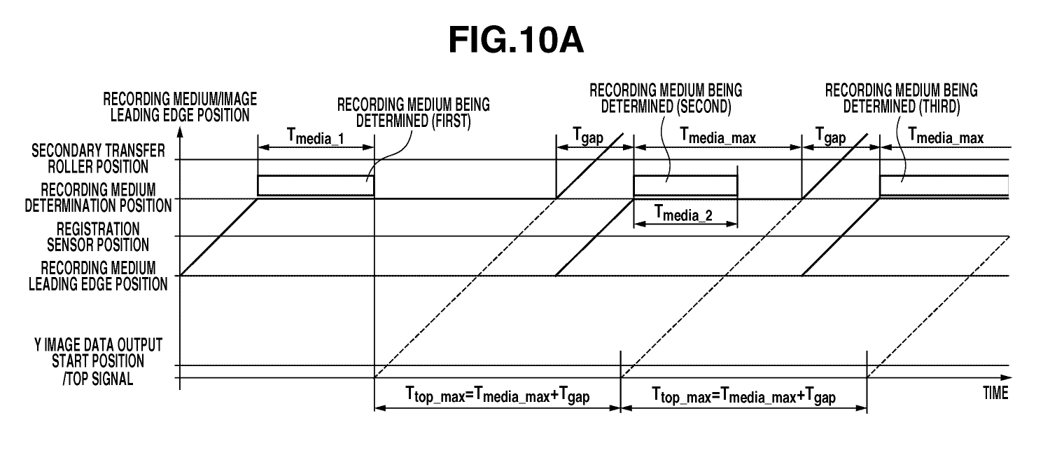

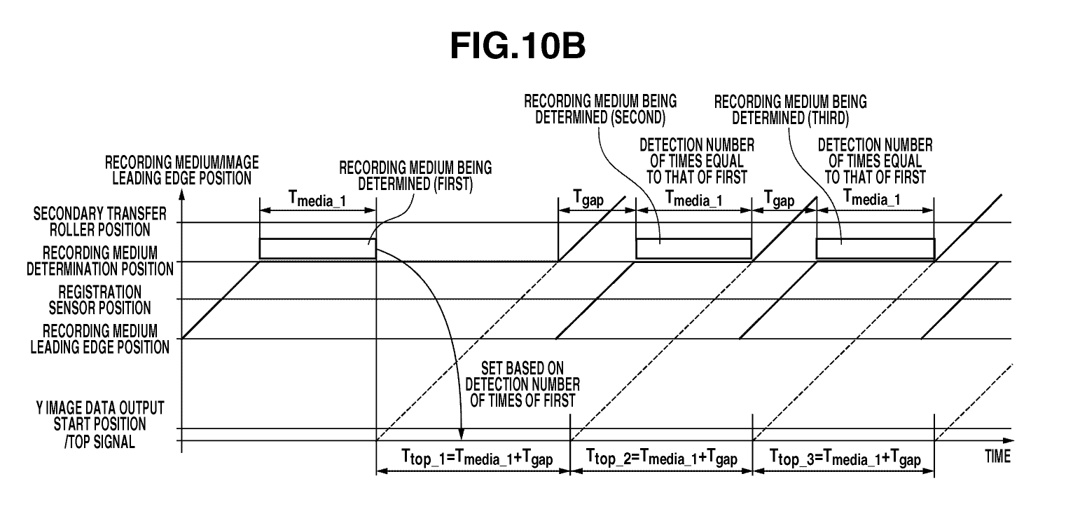

Timing charts of FIGS. 10A and 10B illustrate conveying positions of a recording medium and a toner image, and timing in determination of the recording medium. Referring to the timing charts illustrated in FIGS. 10A and 10B, determination control of the recording medium according to the present exemplary embodiment is described.

A horizontal axis indicates time, and a vertical axis indicates a conveying distance from a feeding cassette 102 along a conveyance path, and a conveying distance of a toner image. A transmission position of a /TOP signal is calculated from an exposure position of yellow (image data output start position) and a secondary transfer roller position. In FIGS. 10A and 10B, a leading edge position of the recording medium is indicated by a solid line, and a leading edge position of the toner image is indicated by a dotted line.

First, a conventional determination operation of a recording medium illustrated in FIG. 10A is described. An image forming apparatus 101 feeds the recording medium from a feeding cassette 102, detects a leading edge of the recording medium by a registration sensor 109, and conveys the recording medium to a recording medium determination sensor 300.

A paper type mode is indefinite for a first recording medium of a printing start timing, and hence a paper type mode is determined based on a determination result of the recording medium, and a /TOP signal is transmitted after a conveying speed of the recording medium is determined. Then, the conveyance of the recording medium is resumed at timing of conveying a toner image formed by using the /TOP signal as a reference to a secondary transfer position. In this case, determination operation time T_{media}_{_{—}}₁ of the first recording medium is determined based on the number of times of detecting a determination result in one recording medium, which is determined according to detected glossiness and transmittance.

For a second recording medium and after from the printing start timing, images are formed by the paper type mode determined for the first recording medium and, before the recording medium determination operation is ended, a /TOP signal is transmitted to start forming toner images.

In an image forming apparatus 101 that includes an intermediate transfer belt 104 according to the present exemplary embodiment, a distance from an exposure start position of yellow to the secondary transfer position is longer than that from a recording medium determination position to the secondary transfer position. Thus, by transmitting the /TOP signal before the end of the recording medium determination operation, a drop in productivity during the recording medium determination operation is suppressed.

In this case, /TOP signal transmission timing Tₜₒₚ_{_{—}}ₘₐₓ=T_{media}_{_{—}}ₘₐₓ+T_{gap} for the second recording medium and after from the printing start timing is determined based on longest recording medium determination operation time T_{media}_{_{—}}ₘₐₓ and a recording medium interval T_{gap}. Second recording medium determination operation time T_{media}_{_{—}}₂ is determined based on the number of times of detecting a determination result in one recording medium, which is determined according to glossiness and transmittance detected from the second recording medium.

However, this time is indefinite before the recording operation determination operation, and hence transmission timing of a /TOP signal is determined based on the longest recording medium determination operation time T_{media}_{_{—}}ₘₐₓ. The longest recording medium determination operation time T_{media}_{_{—}}ₘₐₓ is defined based on the maximum number of times of detecting glossiness and transmittance in one recording medium. The recording medium interval T_{gap} is calculated based on lengths of recording media and a predefined gap between pieces of paper to prevent overlapping of a trailing edge and a leading edge of the continuously conveyed recording media in the recording medium determination start position.

A recording medium determination operation according to the present exemplary embodiment illustrated in FIG. 10B is described. An operation up to a second recording medium from a printing start timing is similar to that of the conventional method.

For the second recording medium and after from the printing start timing, a recording medium determination operation is performed for one recording medium based on the number of detection times (glossiness and transmittance) equal to that for the first recording medium of the printing start. In other words, even for the second recording medium and after from the printing start timing, the recording medium determination operation is performed with the determination operation time T_{media}_{_{—}}₁ of the first recording medium of the printing start timing. Thus, transmission timing Tₜₒₚ_{_{—}}₁=T_{media}_{_{—}}₁+T_{gap} of a /TOP signal can be set.

As a result, when the recording medium determination operation time T_{media}_{_{—}}₁+T_{gap} is shorter than the longest recording medium determination operation time T_{media}_{_{—}}ₘₐₓ, a /TOP signal transmission interval is shorter, enabling suppression of a drop in productivity.

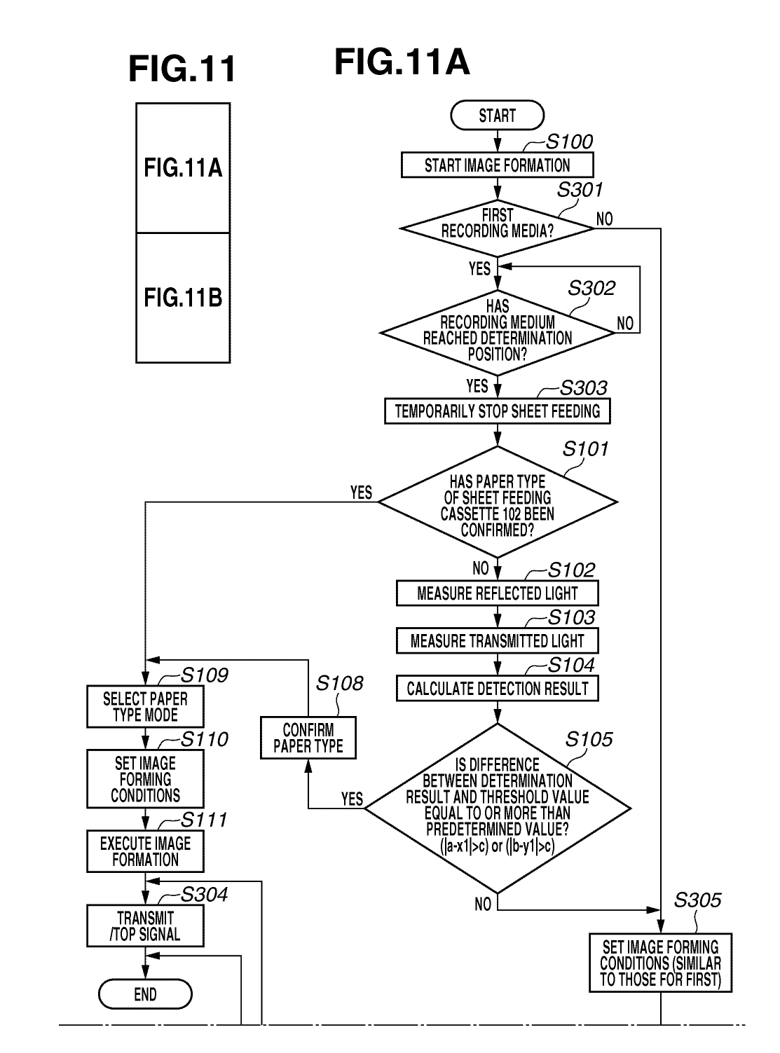

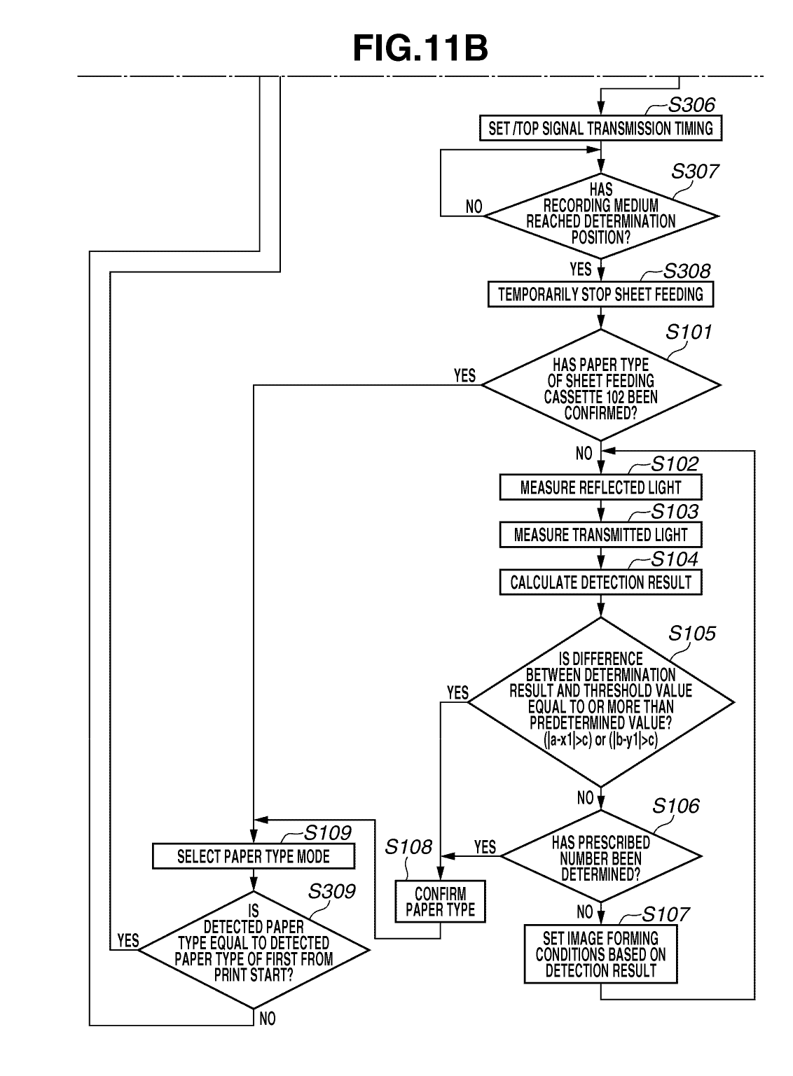

Referring to a flowchart of FIG. 11 (11A and 11B), control of /TOP signal transmission timing according to the present exemplary embodiment is described. Steps similar to those of the first exemplary embodiment illustrated in the flowchart of FIG. 4 have similar reference numerals, and description thereof is omitted.

In step S301, an engine control unit 200 determines whether it is a first recording medium from the printing start timing. When the recording medium is determined as the first recording medium (YES in step S301), in step S302, the engine control unit 200 detects a leading edge of the recording medium by a registration sensor 109, and conveys the recording medium to the detection position of a recording medium determination sensor 300.

In step S303, the engine control unit 200 temporarily stops the feeding to stop the recording medium. When the type of the recording medium is not confirmed in steps S101 to S106, the processing proceeds to step S305. When the type of the recording medium is confirmed in steps S101 to S106, in step S304, the engine control unit 200 transmits a /TOP signal.

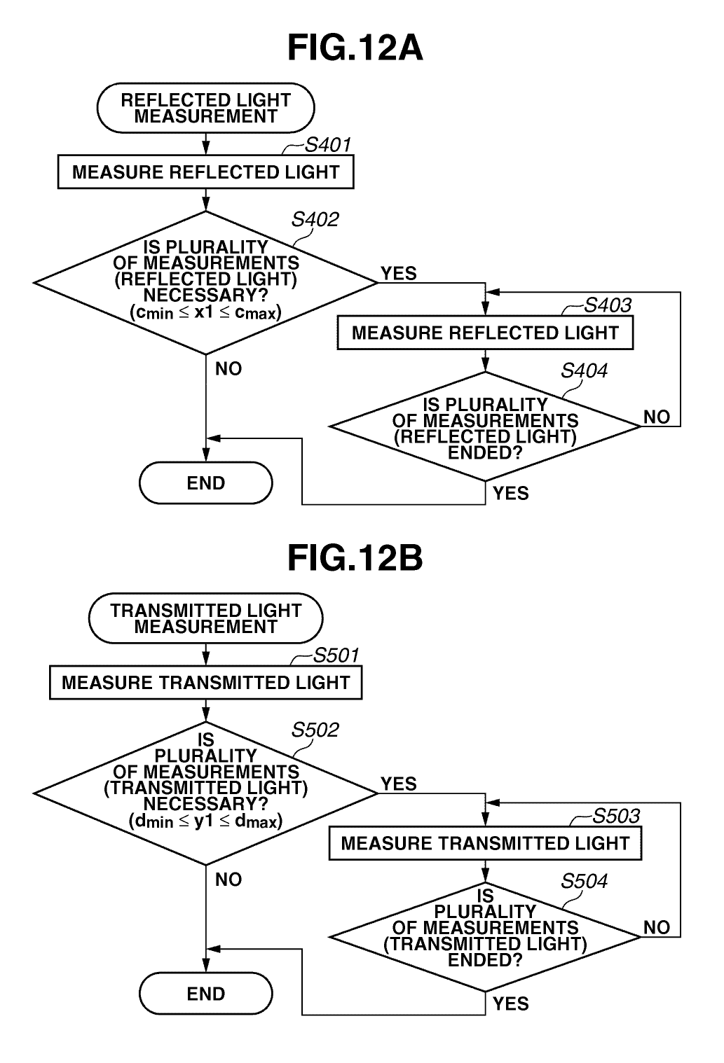

Referring to flowcharts of FIGS. 12A and 12B, a method for determining the number of detection times during reflected light measurement in step S102 and a method for determining the number of detection times during transmitted light measurement in step S103 are described.

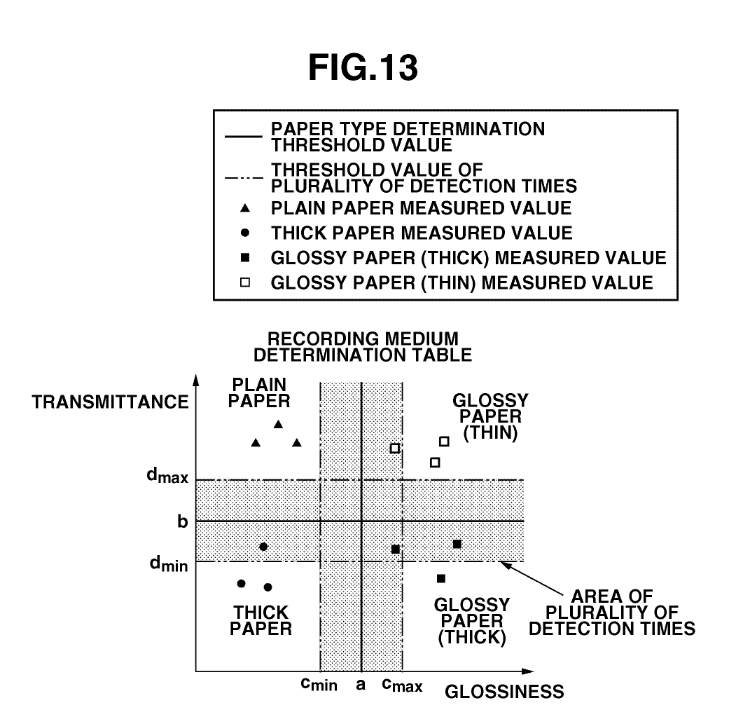

FIG. 12A is a flowchart illustrating the reflected light measurement. In step S401, the reflected light is received by phototransistors 303 and 304. In step S402, the engine control unit 200 determines the number of detection times based on whether glossiness x₁ is near a threshold value “a” (cₘᵢₙ≦x1≦Cₘₐₓ) for the first recording medium of the printing start timing as indicated in a recording medium determination table illustrated in FIG. 13.

The engine control unit 200 determines the number of detection times by calculating a specular reflection output value and a diffused reflection output value indicating the glossiness x₁ of the recording medium from output values of the phototransistors 303 and 304. When the glossiness x₁ of the recording medium is near the threshold value “a” (YES in step S402), in step S403, to improve detection accuracy of the glossiness, the engine control unit 200 further measures the reflected light. In step S404, the engine control unit 200 determines whether to continue the measurement of the reflected light.

FIG. 12B is a flowchart illustrating the transmitted light measurement. In step S501, the transmitted light is received by the phototransistor 304. In step S502, the engine control unit 200 determines the number of detection times based on whether transmittance y₁ is near a threshold value “b” (dₘᵢₙ≦y1≦dₘₐₓ) for the first recording medium of the printing start as indicated in the recording medium determination table illustrated in FIG. 13.

The engine control unit 200 calculates the transmittance y₁ indicating light transmissivity of the recording medium from an output value of the phototransistor 304. When the transmittance y₁ is near the threshold value “b” (YES in step S502), in step S503, to improve detection accuracy of the transmittance, the engine control unit 200 further measures the transmitted light. In step S504, the engine control unit 200 determines whether to continue the measurement of the transmitted light.

When it is not the first recording medium from the printing start timing (NO in step S301), in step S305, the engine control unit 200 sets image forming conditions according to a paper type mode determined for the first paper. In step S306, the engine control unit 200 sets /TOP signal transmission timing.

In this case, the engine control unit 200 sets /TOP signal transmission timing Tₜₒₚ_{_{—}}_{1 (=T}_{media}_{_{—}}₁+T_{gap}) by performing a recording medium determination operation with the number of detection times (glossiness and transmittance) equal to that for the first recording medium of the printing start. The engine control unit 200 then transmits a /TOP signal at the set /TOP signal transmission timing Tₜₒₚ_{_{—}}₁ based on a /TOP signal for the last recording medium.

In step S307, the engine control unit 200 detects a leading edge of the recording medium by the registration sensor 109, and conveys the recording medium to the detection position of the recording medium determination sensor 300. In step S308, the engine control unit 200 temporarily stops the feeding to stop the recording medium. In steps s101 to S109, the engine control unit 200 determines the recording medium.

In step S309, the engine control unit 200 determines whether types of the recording media determined by a determination operation of the second recording medium and after match that of the first recording medium of the printing start.

When the types of the recording media match that of the first recording medium of the printing start (YES in step S309), the engine control unit 200 transmits a /TOP signal. When the types do not match that of the first recording medium of the printing start (NO instep s309), the engine control unit 200 notifies a user of a mixture of different types of recording media in the feeding cassette 102, and discharges the recording media.

Thus, by controlling the number of detection times during determination of a next recording medium and after and /TOP signal transmission timing based on parameters detected from the first recording medium of the recording start, a drop in productivity during determination of the types of the recording media can be suppressed.

The present exemplary embodiment has been described by taking the phototransistor as the example of the light receiving unit. However, a CCD sensor, a CMOS sensor, or a recording medium determination unit using an ultrasonic wave can be used as a reading unit for reading the inside of a light irradiation area of the light emitting unit. As long as detection of the same recording media is performed by a plurality of times, as in the case of the first exemplary embodiment, based on the number of detection times of the same recording medium, /TOP signal transmission timing can be determined.

The present exemplary embodiment has been described by taking the example of the recording medium determination unit 300 that can detect both glossiness (surface texture) and transmittance (thickness) of the recording medium. However, a recording medium determination sensor that detects one of glossiness and transmittance can be used.

The present exemplary embodiment has been described by taking the example where the number of detection times of the same recording medium determined in the first recording medium of the printing start is applied to all the recording media of the second and after. However, based on a determination result of the last recording medium, timing of resetting the number of detection times to transmit a /TOP signal can be determined.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Applications No. 2010-149489 filed Jun. 30, 2010 and No. 2010-208025 filed Sep. 16, 2010, which are hereby incorporated by reference herein in their entirety.

What is claimed is:

1. An image forming apparatus comprising:
a detection unit configured to detect a value indicating a type of a recording medium; and
a control unit configured to end the detection performed by the detection unit when a difference between a first value detected by the detection unit and a threshold value is larger than a predetermined value, continue the detection performed by the detection unit when the difference between the first detection value detected by the detection unit and the threshold value is smaller than the predetermined value, and end the detection performed by the detection unit when a difference between a second value detected after the first value by the detection unit and the threshold value is larger than the predetermined value.

2. An image forming apparatus according to claim 1, wherein the control unit determines a type of the recording medium based on the value detected by the detection unit and the threshold value.

3. An image forming apparatus according to claim 1, wherein the control unit continues the detection performed by the detection unit when a difference between a value detected from a recording medium conveyed before by the detection unit and the threshold value is smaller than the predetermined value, and ends the detection performed by the detection unit when a case where a difference between a value detected from a recording medium conveyed after the recording medium conveyed before by the detection unit and the threshold value is small continues for a predetermined number of recording media.

4. An image forming apparatus according to claim 1, wherein the detection unit includes:
an irradiation unit configured to irradiate a recording medium with light; and
an imaging unit configured to capture an image of the light with which the irradiation unit irradiates the recording media.

5. An image forming apparatus according to claim 1, wherein when the difference between the value detected by the detection unit and the threshold value is larger than the predetermined value, the control unit ends the detection performed by the detection unit if the type of the recording medium is confirmed to be plain paper based on the value detected by the detection unit, and continues the detection performed by the detection unit for a predetermined number of recording media if the type of the recording media is not confirmed to be plain paper based on the value detected by the detection unit.

6. An image forming apparatus according to claim 1, further comprising an image forming unit configured to form an image on the recording medium,
wherein the control unit controls image forming conditions for the image forming unit based on the value detected by the detection unit and the threshold value.

7. An image forming apparatus according to claim 3, wherein the control unit determines the type of the recording medium based on the value detected by the detection unit for the predetermined number of recording media.

8. An image forming apparatus comprising:
a detection unit configured to detect a first value indicating a type of a recording medium from a first recording medium and a second value indicating a type of a recording medium from a second recording medium; and
a control unit configured to calculate a difference value between the first value and the second value detected by the detection unit, continue the detection performed by the detection unit when the difference value is larger than a predetermined value, and end the detection performed by the detection unit when the difference value between the first value and the second value detected by the detection unit is smaller than the predetermined value.

9. An image forming apparatus according to claim 8, wherein the control unit calculates an average value of the first value and the second value when the difference value between the first value and the second value detected by the detection unit is smaller than the predetermined value, and determines the type of the recording media based on a threshold value and the average value.

10. An image forming apparatus according to claim 8, further comprising an image forming unit configured to form an image on a recording medium,
wherein when the difference value between the first value and the second value detected by the detection unit is smaller than the predetermined value, the control unit calculates an average value of the first value and the second value, and controls image forming conditions for the image forming unit based on a threshold value and the average value.

11. An image forming apparatus comprising:
a detection unit configured to detect a value indicating a type of a recording medium;
an image forming unit configured to form an image on the recording medium;
a transmission unit configured to transmit a signal to start writing the image by the image forming unit; and
a control unit configured to continue the detection performed by the detection unit without determining the type of the recording medium when a difference between a value detected by the detection unit and a threshold value is smaller than a predetermined value, determine the type of the recording medium based on the value when the difference between the value detected by the detection unit and the threshold value is larger than the predetermined value, and control timing of transmitting the signal by the transmission unit based on the number of times of detecting the value by the detection unit until the type of the recording medium is determined.

12. An image forming apparatus comprising:
a detection unit configured to detect a value indicating a type of a recording medium; and
a control unit configured to end the detection performed by the detection unit when a difference between a value detected by the detection unit and a threshold value is larger than a predetermined value, detect a predetermined number of recording media by the detection unit when the difference between the detection value detected by the detection unit and the threshold value is smaller than the predetermined value, and then end the detection performed by the detection unit.

13. An image forming apparatus comprising:
a detection unit configured to detect a value indicating a type of recording medium; and
a control unit configured to continue the detection performed by the detection unit when a value detected by the detection unit is within an area indicating whether to continue the preset detection performed by the detection unit, and end the detection when the value detected by the detection unit is outside the area after the detection is continued.

14. An image forming apparatus according to claim 13, wherein the control unit determines a number of recording media according to the area in which the value is present.
